(19) United States
(12) Patent Application Publication
(10) Pub. No.: US 2026/0291592 A1
(43) Pub. Date: Sep. 24, 2026

(54) METHOD AND APPARATUS FOR AI/ML BASED RRM UTILIZING SSB INDEX POINTS

(71) Applicant: Apple Inc., Cupertino, CA (US)

(72) Inventors: Konstantinos SARRIGEORGIDIS, Los Gatos, CA (US); Yang TANG, San Jose, CA (US); Jie CUI, San Jose, CA (US)

(21) Appl. No.: 19/472,627

(22) PCT Filed: Apr. 4, 2024
(86) PCT No.: PCT/US2024/023046

§ 371 Date: Oct. 3, 2025

Related U.S. Application Data
(60) Provisional application No. 63/457,702, filed on Apr. 6, 2023.

(51) Int. Cl. H04B 7/06; H04B 17/318; H04L 41/16; H04W 56/00; H04W 76/20

(52) U.S. Cl. CPC H04B 7/0696; H04B 17/328; H04L 41/16; H04W 56/0015; H04W 76/20

(57) ABSTRACT

Embodiments relate to a method and apparatus for artificial intelligence/machine learning (AI/ML) based radio resource management (RRM) utilizing synchronization signal block (SSB) index points. In particular, embodiments relate to employing deep learning utilizing AI/ML algorithms by a UE to learn mapping between low to high resolution mapping. In one embodiment, a process implemented by the UE includes: selecting a sub-sample of beams from the base station based upon X and Y spatial coordinates from SSB index points. Further, based on the selection of the sub-sample of beams based upon the X and Y spatial coordinates from SSB index points, the process further implements an artificial intelligence/machine learning (AI/ML) model function to: generate a course training image map; generate a prediction image map from the course training image map; and select an optimal beam pair from the prediction image map for communication with the base station.

### CROSS-REFERENCE TO RELATED APPLICATIONS

This application claims the benefit of and priority to U.S. Provisional Patent Application No. 63/457,702 filed Apr. 6, 2023. The entirety of which is incorporated herein by reference.

### FIELD OF INVENTION

This invention relates generally to the field of wireless communication, and more particularly, to a method and apparatus for artificial intelligence/machine learning (AI/ML) based radio resource management (RRM) utilizing synchronization signal block (SSB) index points.

### BACKGROUND OF THE INVENTION

In a wireless communications network, a user equipment (UE) may communicate with a base station of the network by establishing a radio link between the UE and the base station. In a 5G (New Radio or NR) or 4G (LTE) wireless network, a UE may receive signaling and data from the serving base station in a downlink (DL) transmission direction or transmit signaling and data to the serving base station in an uplink (UL) transmission direction.

The Study Item (SI) of RP-213599 is to explore the benefits of augmenting the air-interface with features enabling improved support of artificial intelligence/machine learning (AI/ML) based algorithms for enhanced performance and/or reduced complexity/overhead. However, radio resource management (RRM) and L1 measurement enhancement from the UE perspective has not been the focus of the existing radio access network 1 (RAN1) led SI. It is noted that the overhead of reference signals (RS) used for RRM (i.e., the synchronization signal block (SSB) and channel state reference information reference signal (CSI-RS)) is quite high in the current new radio (NR) design. For example, when SSB based measurement timing configuration (SMTC) periodicity is 20 ms, the related SMTC overhead in the frequency range (FR2) is approximately 25%, which is very high. It would be quite beneficial to reduce the number of beams at both Tx and/or Rx in measurements, while maintaining the existing delay and accuracy requirements unchanged.

### SUMMARY OF THE DESCRIPTION

Embodiments relate to a method and apparatus for artificial intelligence/machine learning (AI/ML) based radio resource management (RRM) utilizing synchronization signal block (SSB) index points and including wide and fine beam searches. According to embodiments to be described hereafter, potential enhancement on RRM functionality may be accomplished with an AI/ML model function implemented by the UE. In one embodiment, in order to reduce the overhead and increase throughput it would be preferable to reduce the training overhead from full search to a partial search by the UE. As an example, as will be described, reference signal received power (RSRP) values across the full Rx, Tx beam sweep can be thought as an image where individual pixels represent the RSRP value for each Rx, Tx beam combination. Reduced measurements will result in sub-sampling the full image and will represent a low-resolution image. Therefore, proposed embodiments may be related to employing deep learning utilizing AI/ML algorithms by the UE to learn the mapping between low to high resolution mapping. By utilizing embodiments of AI/ML algorithms implemented by the UE to be hereafter described, RRM performance enhancements can be achieved.

Embodiments relate to a method and apparatus for artificial intelligence/machine learning (AI/ML) based radio resource management (RRM) utilizing synchronization signal block (SSB) index points. In particular, embodiments relate to employing deep learning utilizing AI/ML algorithms by a UE to learn mapping between low to high resolution mapping. In one embodiment, a process implemented by the UE includes: selecting a sub-sample of beams from the base station based upon X and Y spatial coordinates from SSB index points. Further, based on the selection of the sub-sample of beams based upon the X and Y spatial coordinates from SSB index points, the process further implements an artificial intelligence/machine learning (AI/ML) model function to: generate a course training image map; generate a prediction image map from the course training image map; and select an optimal beam pair from the prediction image map for communication with the base station.

In one embodiment, the X spatial coordinate from the SSB index point is a number that indicates the spatial direction order of the beam in azimuth. In one embodiment, the Y spatial coordinate from the SSB index point is a number that indicates the spatial direction order of the beam in elevation. In one embodiment, the sub-sample of beams includes narrow beams. In one embodiment, the sub-sample of beams includes wide beams. In one embodiment, the AI/ML model function is based upon 8×8 uniform planar array (UPA) Tx and a 4×4 Rx antenna array. In one embodiment, the optimal beam pair from the prediction image map for communication with the base station includes a Tx, Rx pair. In one embodiment, the course training image map is generated based upon training data of {X input, Y output} pairs, wherein X input represents a subset of beam pair reference signal received power (RSRP) measurements and the Y output represents the true full search RSRP measurements. In one embodiment, the AI/ML model function is trained to find an inverse function: ƒ⁻¹(X)→Ŷ, wherein Ŷ corresponds to the prediction image map and X corresponds to the course training image map. In one embodiment, the AI/ML model function predicts the optimal beam pair p {Tx,Rx} based upon an interpolated map [\hat{r},\hat{t}]_{1:p}=g(Ŷ), where g( ) returns the optimal peaks in Ŷ corresponding to the predicted image map. In one embodiment, an additional field is included inside a radio resource control (RRC) configuration where spatial information is specified for the SSB burst including a coordinate system for the X and Y spatial coordinates. In one embodiment, the sub-sample of beams includes wide beams and the wide beams are identified in an RRC configuration including a wide beam sweep and the size of the wide beams.

In another type of embodiment, a user equipment (UE) to implement radio resource management (RRM) for the UE, the UE in connection with a base station, is disclosed. The UE comprises: at least one antenna; at least one radio, wherein the at least one radio is configured to communicate with the base station using the at least one antenna; and at least one processor coupled to the at least one radio. The at least one processor is configured to perform operations comprising: selecting a sub-sample of beams via the antenna from the base station based upon X and Y spatial coordinates from SSB index points; based on the selection of the sub-sample of beams based upon the X and Y spatial coordinates from SSB index points, implementing an artificial intelligence/machine learning (AI/ML) model function to: generate a course training image map; generate a prediction image map from the course training image map; and select an optimal beam pair from the prediction image map for communication with the base station.

In one embodiment, the X spatial coordinate from the SSB index point is a number that indicates the spatial direction order of the beam in azimuth. In one embodiment, the Y spatial coordinate from the SSB index point is a number that indicates the spatial direction order of the beam in elevation. In one embodiment, the sub-sample of beams includes narrow beams. In one embodiment, the sub-sample of beams includes wide beams. In one embodiment, the AI/ML model function is based upon 8×8 uniform planar array (UPA) Tx and a 4×4 Rx antenna array. In one embodiment, the optimal beam pair from the prediction image map for communication with the base station includes a Tx, Rx pair. In one embodiment, the course training image map is generated based upon training data of {X input, Y output} pairs, wherein X input represents a subset of beam pair reference signal received power (RSRP) measurements and the Y output represents the true full search RSRP measurements. In one embodiment, the AI/ML model function is trained to find an inverse function: ƒ⁻¹(X)→Ŷ, wherein Ŷ corresponds to the prediction image map and X corresponds to the course training image map. In one embodiment, the AI/ML model function predicts the optimal beam pair p {Tx,Rx} based upon an interpolated map [\hat{r},\hat{t}]_{1:p}=g(Ŷ), where g( ) returns the optimal peaks in Ŷ corresponding to the predicted image map. In one embodiment, an additional field is included inside a radio resource control (RRC) configuration where spatial information is specified for the SSB burst including a coordinate system for the X and Y spatial coordinates. In one embodiment, the sub-sample of beams includes wide beams and the wide beams are identified in an RRC configuration including a wide beam sweep and the size of the wide beams.

Other methods and apparatuses are also described.

### BRIEF DESCRIPTION OF THE DRAWINGS

The present invention is illustrated by way of example and not limitation in the figures of the accompanying drawings in which like references indicate similar elements.

FIG. 1 illustrates an example wireless communication system according to one embodiment of the disclosure.

FIG. 2 illustrates user equipment in direct communication with a base station (BS) according to one embodiment of the disclosure.

FIG. 3 illustrates an example block diagram of a UE according to one embodiment of the disclosure.

FIG. 4 illustrates an example block diagram of a BS according to one embodiment of the disclosure.

FIG. 5 illustrates an example block diagram of cellular communication circuitry according to one embodiment of the disclosure.

FIG. 6 illustrates a flow diagram of a process to implement radio resource management (RRM) for the UE according to one embodiment of the disclosure.

FIG. 7A shows a diagram of fine beams from a base station to one more UEs according to one embodiment of the disclosure.

FIG. 7B shows a diagram of wide beams from a base station to one more UEs according to one embodiment of the disclosure.

FIG. 8 shows image maps to illustrate a description of training of the AI/ML model function of the UE according to one embodiment of the disclosure.

FIG. 9A shows a chart diagram illustrating the accuracy of the previously described methods for wide beam and narrow band training according to one embodiment of the disclosure.

FIG. 9B shows a chart diagram illustrating the accuracy of the previously described methods for wide beam and narrow band training according to one embodiment of the disclosure.

FIG. 10 shows a chart diagram illustrating various SSB index points for beams that include their X, Y, Z, measurements according to one embodiment of the disclosure.

FIG. 11 shows a flow diagram of a process to implement radio resource management (RRM) for the UE including the use of X and Y spatial coordinates from SSB index points measurements according to one embodiment of the disclosure.

### DETAILED DESCRIPTION

In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “some embodiments” or “an embodiment” means that a particular feature, structure, or characteristic described in connection with the embodiment can be included in at least one embodiment of the invention. The appearances of the phrase “in some embodiments” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

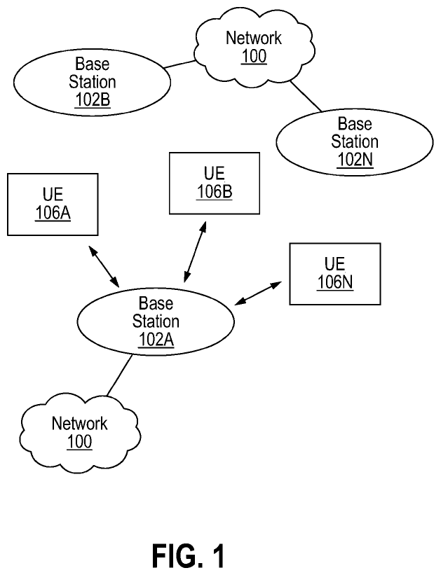

FIG. 1 illustrates a simplified example wireless communication system according to one aspect of the disclosure. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

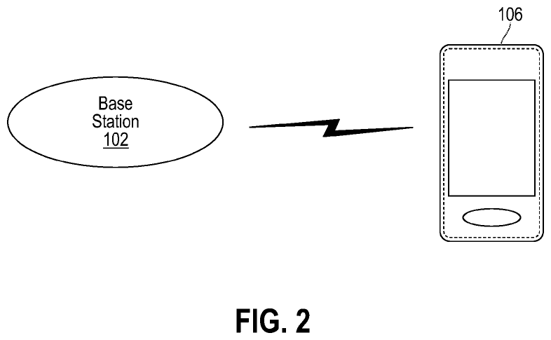

FIG. 2 illustrates a UE 106 in direct communication with a base station 102 through uplink and downlink communications according to one aspect of the disclosure. The UE 106 may be a device with cellular communication capability such as a mobile phone, a hand-held device, a computer or a tablet, or virtually any type of wireless device. The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1×RTT or LTE or GSM), and separate radios for communicating using each of Wi-Fi and Bluetooth. Other configurations are also possible.

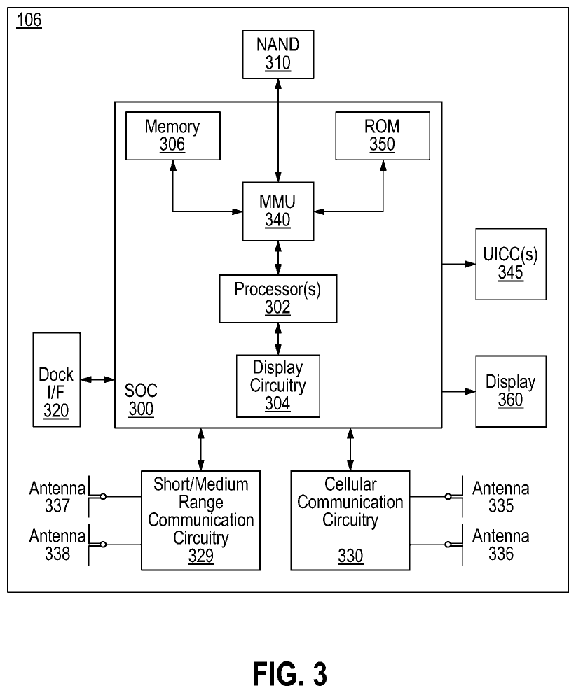

FIG. 3 illustrates an example simplified block diagram of a communication device 106 according to one aspect of the disclosure. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some embodiments, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include dedicated receive chains (including and/or coupled to, e.g., communicatively; directly or indirectly. dedicated processors and/or radios) for multiple radio access technologies (RATs) (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. The communication device 106 may also be configured to determine a physical downlink shared channel scheduling resource for a user equipment device and a base station. Further, the communication device 106 may be configured to group and select CCs (component carriers) from the wireless link and determine a virtual CC from the group of selected CCs. The wireless device may also be configured to perform a physical downlink resource mapping based on an aggregate resource matching patterns of groups of CCs.

As described herein, the communication device 106 may include hardware and software components for implementing the above features for determining a physical downlink shared channel scheduling resource for a communications device 106 and a base station. The processor 302 of the communication device 106 may be configured to implement part or all of the features described herein, e.g., by executing program instructions stored on a memory medium (e.g., a non-transitory computer-readable memory medium). Alternatively, (or in addition), processor 302 may be configured as a programmable hardware element, such as an FPGA (Field Programmable Gate Array), or as an ASIC (Application Specific Integrated Circuit). Alternatively, (or in addition), the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, cellular communication circuitry 330 and short range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etc.) configured to perform the functions of cellular communication circuitry 230. Similarly, the short range wireless communication circuitry 329 may include one or more ICs that are configured to perform the functions of short range wireless communication circuitry 32. In addition, each integrated circuit may include circuitry (e.g., first circuitry, second circuitry, etc.) configured to perform the functions of short range wireless communication circuitry 329.

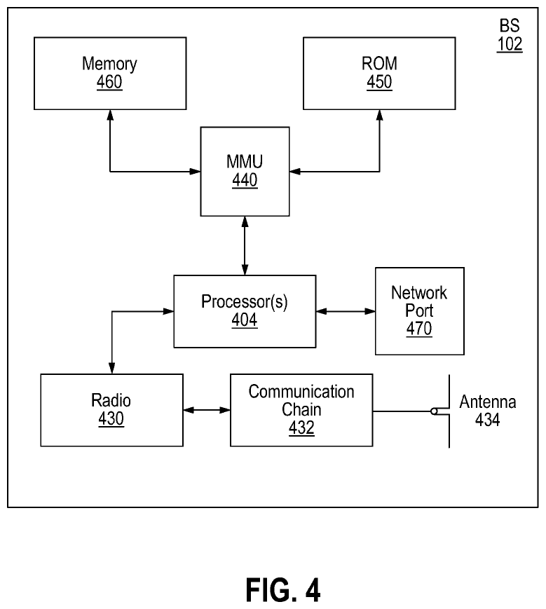

FIG. 4 illustrates an example block diagram of a base station 102 according to one aspect of the disclosure. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UEs 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UEs 106. In some cases, the network port 470 may couple to a telephone network via the core network, and/or the core network may provide a telephone network (e.g., among other UEs serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UEs 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively, (or in addition), the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

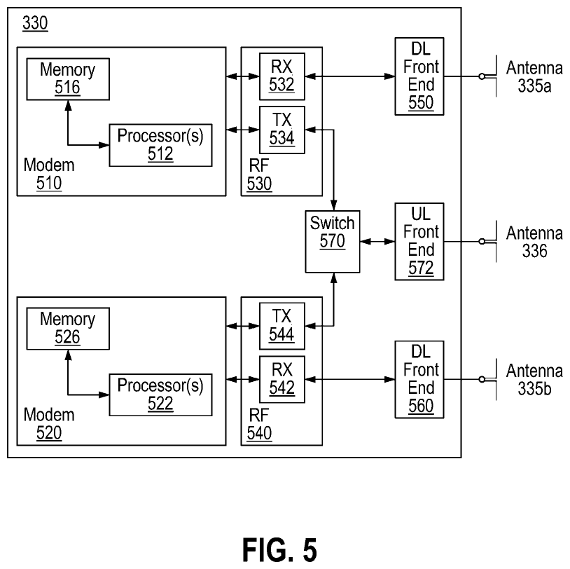

FIG. 5 illustrates an example simplified block diagram of cellular communication circuitry according to one aspect of the disclosure. It is noted that the block diagram of the cellular communication circuitry of FIG. 5 is only one example of a possible cellular communication circuit. According to embodiments, cellular communication circuitry 330 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335 a-b and 336 as shown (in FIG. 3). In some embodiments, cellular communication circuitry 330 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for selecting a periodic resource part for a user equipment device and a base station, as well as the various other techniques described herein. The processors 512 may be configured to implement part or all of the features described herein, e.g., by executing program instructions stored on a memory medium (e.g., a non-transitory computer-readable memory medium). Alternatively, (or in addition), processor 512 may be configured as a programmable hardware element, such as an FPGA (Field Programmable Gate Array), or as an ASIC (Application Specific Integrated Circuit). Alternatively, (or in addition), the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for selecting a periodic resource on a wireless link between a UE and a base station, as well as the various other techniques described herein. The processors 522 may be configured to implement part or all of the features described herein, e.g., by executing program instructions stored on a memory medium (e.g., a non-transitory computer-readable memory medium). Alternatively, (or in addition), processor 522 may be configured as a programmable hardware element, such as an FPGA (Field Programmable Gate Array), or as an ASIC (Application Specific Integrated Circuit). Alternatively, (or in addition), the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

As has been described, the Study Item (SI) of RP-213599 is to explore the benefits of augmenting the air-interface with features enabling improved support of artificial intelligence/machine learning (AI/ML) based algorithms for enhanced performance and/or reduced complexity/overhead. However, radio resource management (RRM) and L1 measurement enhancement from the UE perspective has not been the focus of the existing radio access network 1 (RAN1) led SI. It is noted that the overhead of reference signals (RS) used for RRM (i.e., the synchronization signal block (SSB) and channel state reference information reference signal (CSI-RS)) is quite high in the current new radio (NR) design. For example, when SSB based measurement timing configuration (SMTC) periodicity is 20 ms, the related SMTC overhead in the frequency range (FR2) is approximately 25%, which is very high. It would be quite beneficial to reduce the number of beams at both Tx and/or Rx in L1/3 related measurements, while maintaining the existing delay and accuracy requirements unchanged. Also, the number of training periods in order to perform beam alignment for mmwave results in high communication overhead (with full search across Tx and Rx beams).

According to embodiments to be described hereafter, potential enhancement on RRM functionality may be accomplished with AI/ML model function implemented by the UE 106. By utilizing AI/ML embodiment implementations, L3/L1 measurement delays may be reduced by minimizing the Rx beam sweeping set and scheduling restrictions may be reduced by minimizing L1/3 measurements. Scheduling restrictions imposed during the training periods where the UE 106 performs measurements could reduce throughput. By utilizing embodiments of AI/ML algorithms implemented by the UE 106 to be hereafter described, RRM performance enhancements can be achieved.

In one embodiment, in order to reduce the overhead and increase throughput it would be preferable to reduce the training overhead from full search to a partial search by the UE 106. As an example, as will be described, reference signal received power (RSRP) values across the full Rx, Tx beam sweep can be thought as an image where individual pixels represent the RSRP value for each Rx, Tx beam combination. Reduced measurements will result in sub-sampling the full image and will represent a low-resolution image. Therefore, proposed embodiments may be related to employing deep learning utilizing AI/ML algorithms by the UE 106 to learn the mapping between low to high resolution mapping. In some examples, AI/ML algorithms may include the use of convolutional neural nets.

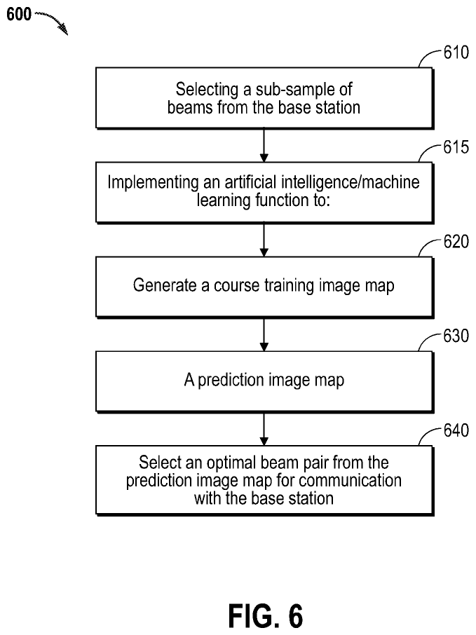

With reference to FIG. 6, FIG. 6 shows a flow diagram of a process 600 to implement radio resource management (RRM) for the UE. The process 600 includes: selecting a sub-sample of beams received via the antenna of the UE 106 from the base station (block 610). Based on the selection of the sub-sample of beams, the process 600 further includes the processor 302 of the UE 106 implementing an artificial intelligence/machine learning function (block 615) to: generate a course training image map (block 620); generate a prediction image map from the course training image map (block 630); and select an optimal beam pair from the prediction image map for communication with the base station 102 (block 640).

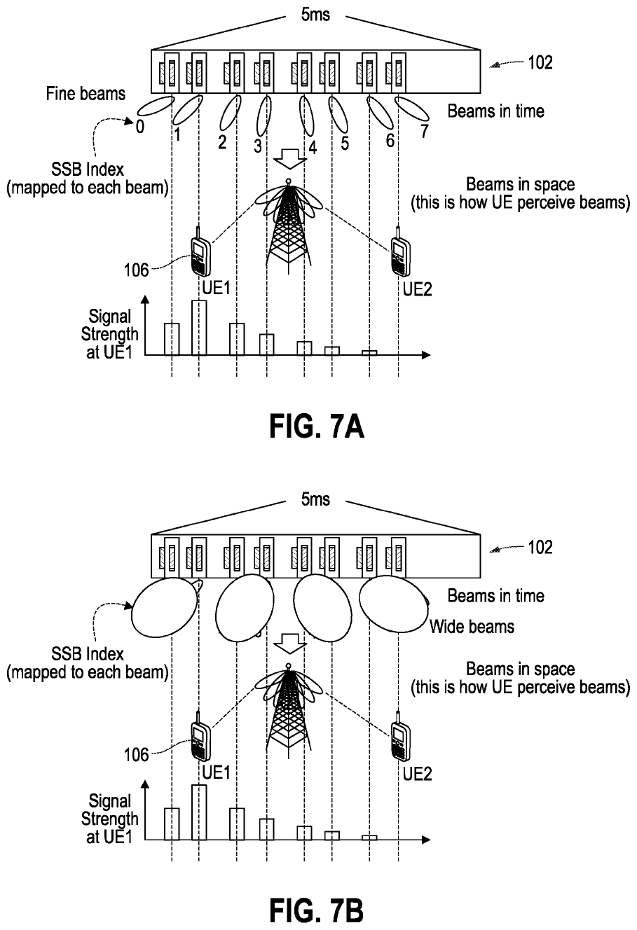

With reference to FIGS. 7A and 7B, an AI/ML based enhancement may be implemented by a UE 106 to reduce overheard. As will be described, the UE 106 may subsample fine beams or wide beams to implement AI/ML based enhancement. In some examples, AI/ML based enhancements may include the use of convolutional neural nets.

As an example, as can be seen in FIG. 7A, base station 102 (e.g., gNB 102) may perform a sweep of Tx beams [0, 1, 2, 3, 4, 5, 6, 7] (including an SSB index mapped to each beam) in a 5 millisecond (ms) burst set to one more UEs (e.g., UE 106). UE 106 is performing measurements with a different Rx beam for each burst set. As can be seen the UE 106 receives beams with different signal strengths. In this example, as shown in FIG. 7A, UE receives 8 Rx beams [0, 1, 2, 3, 4, 5, 6, 7].

As an example, as can be seen in FIG. 7B, base station 102 (e.g., gNB 102) may perform a sweep of Tx beams to one more UEs (e.g., UE 106). In this example, as shown in FIG. 7B, the UE 106 may perform measurements on wide Rx beams. UE 106 may perform measurements with a different wide Rx beam for each burst set. As can be seen the UE 106 receives beams with different signal strengths.

According to embodiments of the invention, an AI/ML model function can be trained by the UE 106 in an offline and supervised manner such that the UE 106 selects a Tx, Rx pair in a much more efficient manner than in prior implementations.

The AI/ML model function of the UE 106 can also be trained online to be fine-tuned based on the environment that the UE is currently residing. Also, the training data can be further split into training data for specifically training the AI/ML model function and validation data in order to tune the hyper-parameters of the AI/ML model function as well as for monitoring the generalization capability of the model.

In order for the AI/ML model function of UE 106 to be trained in an offline and supervised manner such that UE 106 selects a Tx, Rx pair in a much more efficient manner it should be trained with training data. The training data consists of {X,Y} or {input, output} pairs where X represent an ensemble of subset beam pair reference signal received power (RSRP) measurements and the output represent the true labels of the full search RSRP measurements. The AI/ML model function is trained to find an inverse function ƒ⁻¹(X)→Ŷ. The AI/ML model function could be trained to minimize a loss function L(Y,Ŷ). For inference and testing purposes, an independent test data set may be used. In order to implement the AI/ML modeling function, a 3D beamforming scenario may be utilized.

In order for the UE 106 to implement the AI/ML model function, a generic 8×8 uniform planar array (UPA) Tx and a 4×4 Rx antenna array may be utilized. Further, a Tx and Rx Beam codebook for both antenna arrays may be utilized. The wireless channel consists of multiple input-multiple output (MIMO) scattering (cluster, rays) and path gains between the Tx and Rx antenna elements. For each training data realization the 3D placement of the scattering clusters (Angle of Arrival (AoA), Angle of Departure (AoD)) is random as well as the gains of each cluster. For each channel realization a full Tx,Rx codebook beam sweep provides a matrix of RSRP measurements. The RSRP matrix is used as a true label data point, and the subsampled noisy RSRP matrix is used as the input X to the AI/ML model function.

As previously described, the AI/ML model function of the UE 106 will infer the full RSRP map ƒ⁻¹(X)→Ŷ. The AI/ML model function can be used to predict the optimal or best p {Tx,Rx} beam pairs from the interpolated map [\hat{r},\hat{t}]_{1:p}=g(Ŷ), where g( ) returns the optimal or best peaks in Ŷ. The optimum {Tx,Rx} beam is denoted by [r*,t*]=g(Y). Various test data can be utilized and used by the AI/ML model function to infer the optimal or best peaks. In particular, this data may be used to simulate the probability of having [r*,t*]∈[\hat{r},\hat{t}]_{1:p}

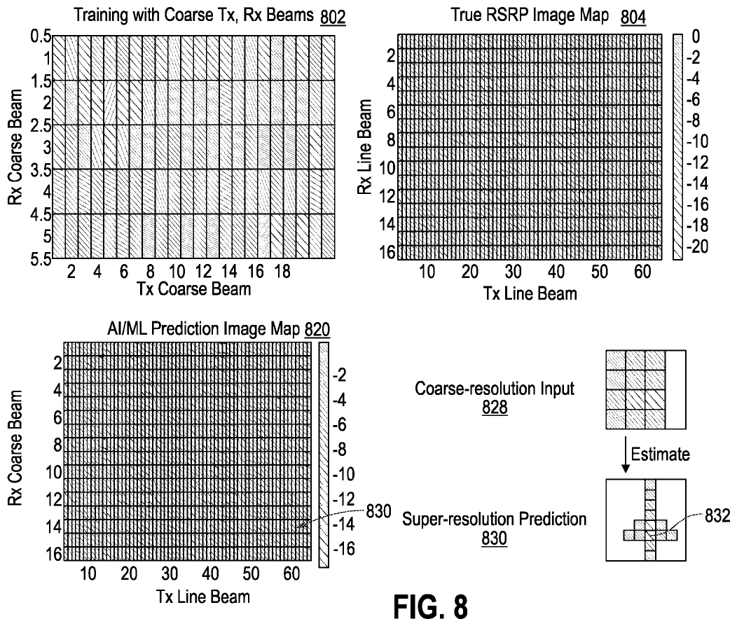

With additional reference to FIG. 8, FIG. 8 illustrates image maps to illustrate a description of training of the AI/ML model function of the UE 106. As can be seen in FIG. 8, image map 802 is a training image with coarse Tx, Rx beams from a base station 102 to a UE 106 for modeling purposes. Image map 804 is the true RSRP image map. Image map 820 is the AI/ML model function prediction image map by the UE.

Therefore, as an example, training image map with Tx, Rx beams 802 may be considered an input X. As an example, image map 802 with Tx, Rx beams may be 22 Tx course beams and 5 Rx course beams, which may be wide beams. This can be seen, as an example, with reference for illustration, to FIG. 7B, which shows wide beams received by UE 106. It should be noted that this is in comparison to what would be a full measurement reading of 64 Tx beams and 16 Rx beams.

By inputting image map 802 readings into the AI/ML model function equation of UE 106: ƒ⁻¹(X)→Ŷ; the AI/ML model function will infer the full AI/ML prediction RSRP image map 820 from the inverse AI/ML model inverse function of ƒ⁻¹(X). As can be seen the AI/ML RSRP prediction image map 820 is very close to the true RSRP image map 804.

Further, as previously described, the AI/ML model function implemented by UE 106 can be used to predict the optimal or best p {Tx,Rx} beam pairs from the interpolated map [\hat{r},\vec{t}]_{1:p}=g(Ŷ), where g( ) returns the optimal or best peaks in Ŷ (where the interpolated map is the AI/ML prediction image map 820). Therefore, based upon trained course Tx, Rx beam inputs to the UE 106 shown in image map 802, the AI/ML model function equation of UE 106 can be used to generate the AI/ML prediction RSRP image map 820, and from the AI/ML prediction RSRP image map 820, an optimal beam pair may be selected for UE 106. As an example, the coarse-resolution input image map 828 shows an image map of the area of the course-resolution input and the super-resolution prediction 830 shows a optimal or best beam pair 832 from the optimal or best p {Tx,Rx} beam pairs from the interpolated map [\hat{r},\hat{t}]_{1:p}=g(Ŷ). In this way, a very accurate AI/ML prediction image map 820 can be generated and an optimal beam pair can be selected for the UE 106.

Training can be accomplished utilizing wide beams or narrow beams and optimal beam pair selection for the UE 106 can be accomplished with wide or narrow beams. The previous example was illustrated utilizing wide beams. As described in the previous example, utilizing wide beams (e.g., 5 wide beams), the UE 106 can perform training utilizing the AI/ML model function of the UE 106 to generate a course training image map and an AI/ML model function prediction image map, and select an optimal beam pair. Utilizing this data, the AI/ML model function and image maps can be fine-tuned and optimal beam pairs identified in an even more efficient manner in subsequent selections of beam pairs for communication with the base station.

It should be appreciated that the same type of training and optimal beam pair selection by the UE 106 can be accomplished utilizing narrow beams. As an example, a sub-set of narrow beams (e.g., narrow beams 1, 4, 7 (FIG. 7A)) may be utilized as inputs for the trained course Tx, Rx beam inputs of an image map 802, the AI/ML model function equation of UE 106 can be used to generate the AI/ML prediction RSRP image map 820, and from the AI/ML prediction RSRP image map 820, an optimal beam pair may be selected for UE 106, based on the narrow beams. Therefore, similar to the wide beam example, narrow beams can be utilized for UE 106 to perform training utilizing the AI/ML model function of the UE 106 to generate a course training image map, and an AI/ML model function prediction image map, and select an optimal beam pair. Utilizing this data, the AI/ML model function and image maps can be fine-tuned and optimal beam pairs identified in an even more efficient manner in subsequent selections of beam pairs for communication with the base station.

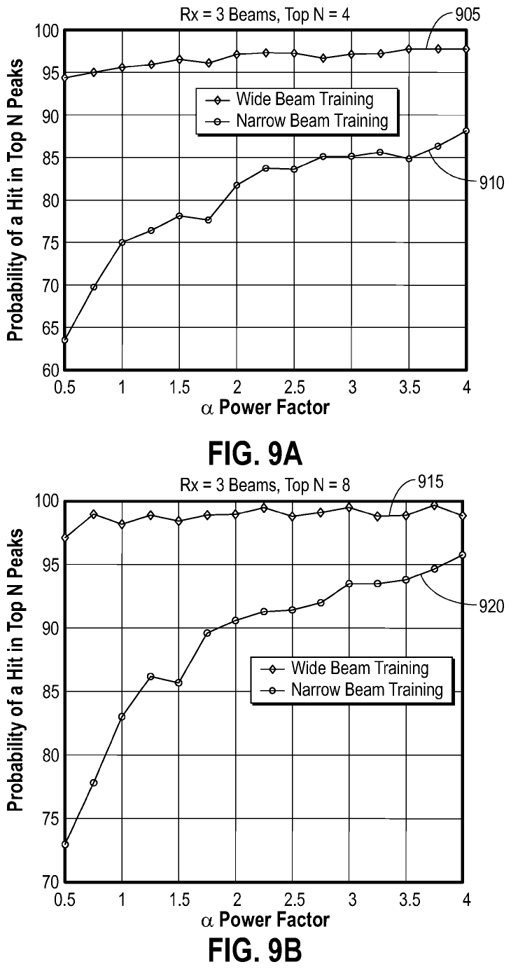

With reference to FIG. 9A, an illustration of the accuracy of the previously described method is disclosed. As to wide beam training, using 2 wide beams, the probability of a hit (e.g., finding an optimal beam pair (e.g., N=4 beam pairs)), as shown by line 905, is generally above 95%. As to narrow beam training, the probability of a hit (e.g., finding an optimal beam pair (e.g., N=4 beam pairs)), as shown by line 910, ranges from generally 65%-90%. With reference to FIG. 9B, an illustration of the accuracy of the previously described method is disclosed. As to wide beam training, using 2 wide beams, the probability of a hit (e.g., finding an optimal beam pair (e.g., N=8 beam pairs)), as shown by line 915, is generally 97.5%-100%. As to narrow beam training, the probability of a hit (e.g., finding an optimal beam pair (e.g., N=8 beam pairs)), as shown by line 920, ranges from generally 75%-95%.

In one embodiment, in order to select wide beam sweeps or fine beam sweeps to implement the AI/ML modeling function of the UE 106, two additional fields may be inserted inside the RRC configuration including the following specifications: (1) Wide vs Fine Beam sweep and (2) The size of the wide beams. This may be seen according to below programming:

```
ServingCellConfigCommon ::= SEQUENCE {
  ....,
  ssb-PositionsInBurst CHOICE {
```

| | |
|---|---|
| shortBitmap | BIT STRING (SIZE (4)), |
| mediumBitmap | BIT STRING (SIZE (8)), |
| longBitmap | BIT STRING (SIZE (64)) |

},

| | |
|---|---|
| ssb-periodicityServingCell | ENUMERATED { ms5, ms10, ms20, |

ms40, ms80, ms160, spare2, spare1 }

```
..
}
  ssbSpatialWideBeamFlag
  ssbSpatialWideBeamSize
```

As has been previously described, the base station 102 (e.g., gNB) configures a SSB index which is mapped to the Tx beam. Based upon this, the UE 106 perform measurements on a SubSet of those SSB beams. Based upon this, the AI/ML modeling function interpolates between the SubSet beams to recover the full set (e.g., the AI/ML prediction RSRP image map 820). Therefore, as has been described, in one embodiment, the optimum SubSet has been determined offline and is used to train AI/ML modeling function.

In order for UE 106 to perform the measurements that will feed the AI/ML modeling function, UE 106 may also determine which of the SSB Indices correspond to the training Subset of SSB indices that the AI/ML was trained with. In some embodiments, to accomplish this, another field can be added inside the RRC configuration where some spatial information is specified to the SSB burst sequence. In this way, the UE 106 knows at which SSBs it will need to perform measurements and feed the AI/ML modeling function.

In one embodiment, an SSB index j of the network (NW) is received by UE 106 through the base station 102 that signals the information X az, Y el, w/n for the UE 106. X is a number that indicates the spatial direction order of the beam in azimuth. Y is a number that indicates the spatial direction order of the beam in elevation. And w/n indicates if the beam is narrow or wide.

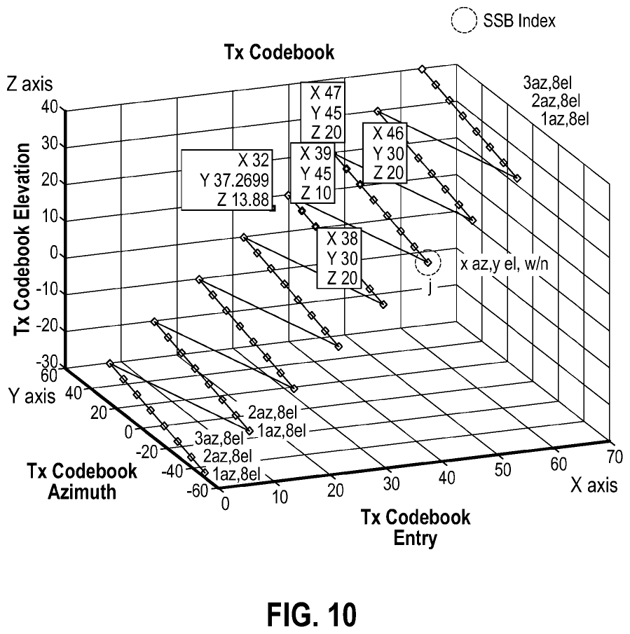

With additional reference to FIG. 10, FIG. 10 shows various SSB index points for beams that include their X, Y, Z, measurements and whether the beam is narrow or wide. The X, Y, Z, measurements may correspond to Tx codebook entries. With this information, UE 106 can decide on the SSB indices that will serve as input measurements to the AI/ML modeling function. UE 106 can select/optimize the SSB indices to optimize performance. Each diamond shape in FIG. 10 shows an SSB index point for a beam that includes its X, Y, Z, measurements and whether the beam is narrow or wide.

For example, if UE 106 only measures 8 beams (out of 64) it could optimize the sampling of the beams (select 8 out of 64) based on this information as shown in FIG. 10. The field w/n should indicate the functional mode of the AI/ML modeling function (e.g., whether it is wide or narrow beam). If the beams are all fine (64 fine beams), the AI/ML modeling function can interpolate between the measured beams (e.g., less than 64). If the w/n field indicates wide beams, then the AI/ML may be fed by measurements on all beams and subsequently zoom-in inside those regions to perform super-resolution and predict the fine beams responses.

The AI/ML modeling function in both cases can predict the top N beams. It expresses those top N beams in the X az, Y el coordinate system. Next time an SSB burst is transmitted it will measure the top N beams at the positions signaled to select the optimal or best beam.

In one embodiment, an additional field can be included inside the RRC configuration where the spatial information is specified to the SSB burst sequence (e.g., the coordinate system x ax, y el). In this way, the UE 106 will know at which SSBs it will need to perform measurements and feed the AI/ML model.

An example of a program to achieve this is below:

```
ServingCellConfigCommon ::= SEQUENCE {
  ....,
  ssb-PositionsInBurst CHOICE {
```

| | |
|---|---|
| shortBitmap | BIT STRING (SIZE (4)), |
| mediumBitmap | BIT STRING (SIZE (8)), |
| longBitmap | BIT STRING (SIZE (64)) |

},

| | |
|---|---|
| ssb-periodicityServingCell | ENUMERATED { ms5, ms10, ms20, |

ms40, ms80, ms160, spare2, spare1 }

..
}
ssbSpatialCoordinatesInBurst
ssbSpatialWideBeamFlag
ssbSpatialWideBeamSize

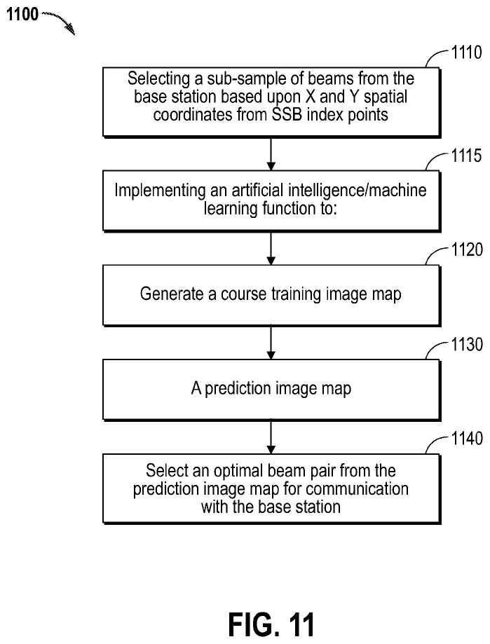

With reference to FIG. 11, FIG. 11 shows a flow diagram of a process 1100 to implement radio resource management (RRM) for the UE. The process 1100 includes: selecting a sub-sample of beams received via the antenna of the UE 106 from the base station based upon X and Y spatial coordinates from SSB index points (block 1110). Based on the selection of the sub-sample of beams based upon X and Y spatial coordinates from SSB index points, the process 1100 further includes the processor 302 of the UE 106 implementing an artificial intelligence/machine learning function (block 1115) to: generate a course training image map (block 1120); generate a prediction image map from the course training image map (block 1130); and select an optimal beam pair from the prediction image map for communication with the base station 102 (block 1140).

In this way, by using the additional process step of selecting a sub-sample of beams received via the antenna of the UE 106 from the base station based upon X and Y spatial coordinates from SSB index points, the previously described procedure is optimized. As previously described, training can be accomplished utilizing wide beams or narrow beams and optimal beam pair selection for the UE 106 can be accomplished with wide or narrow beams. As previously described using wide or narrow beams, the UE 106 can perform training utilizing the AI/ML model function of the UE 106 to generate a course training image map and an AI/ML model function prediction image map, and select an optimal beam pair. Utilizing this data, the AI/ML model function and image maps can be fine-tuned and optimal beam pairs identified in an even more efficient manner in subsequent selections of beam pairs for communication with the base station.

It should be appreciated that the operations of the previously described processes in some embodiments may be performed: at the UE 106 including: a processor, communication interfaces, antenna, a radio, etc., to implement the previously described processes.

There is a number of example embodiments described herein.

Example 1 is a method for radio resource management (RRM) for a user equipment (UE) in communication with a base station comprising: selecting a sub-sample of beams from the base station based upon X and Y spatial coordinates from SSB index points; based on the selection of the sub-sample of beams based upon the X and Y spatial coordinates from SSB index points, implementing an artificial intelligence/machine learning (AI/ML) model function to: generate a course training image map; generate a prediction image map from the course training image map; and select an optimal beam pair from the prediction image map for communication with the base station.

Example 2 is the method of example 1 that may optionally include that the X spatial coordinate from the SSB index point is a number that indicates the spatial direction order of the beam in azimuth.

Example 3 is the method of example 1 that may optionally include that the Y spatial coordinate from the SSB index point is a number that indicates the spatial direction order of the beam in elevation.

Example 4 is the method of example 1 that may optionally include that the sub-sample of beams includes narrow beams.

Example 5 is the method of example 1 that may optionally include that the sub-sample of beams includes wide beams.

Example 6 is the method of example 1 that may optionally include that the AI/ML model function is based upon 8×8 uniform planar array (UPA) Tx and a 4×4 Rx antenna array.

Example 7 is the method of example 1 that may optionally include that the optimal beam pair from the prediction image map for communication with the base station includes a Tx, Rx pair.

Example 8 is the method of example 7 that may optionally include that the course training image map is generated based upon training data of {X input, Y output} pairs, wherein X input represents a subset of beam pair reference signal received power (RSRP) measurements and the Y output represents the true full search RSRP measurements.

Example 9 is the method of example 8 that may optionally include that the AI/ML model function is trained to find an inverse function: ƒ⁻¹(X)→Ŷ, wherein Ŷ corresponds to the prediction image map and X corresponds to the course training image map.

Example 10 is the method of example 9 that may optionally include that the AI/ML model function predicts the optimal beam pair p {Tx,Rx} based upon an interpolated map [\hat{r},\hat{t}]_{1:p}=g(Ŷ), where g( ) returns the optimal peaks in Ŷ corresponding to the predicted image map.

Example 11 is the method of example 1 that may optionally include that an additional field is included inside a radio resource control (RRC) configuration where spatial information is specified for the SSB burst including a coordinate system for the X and Y spatial coordinates.

Example 12 is the method of example 1 that may optionally include that the sub-sample of beams includes wide beams and the wide beams are identified in an RRC configuration including a wide beam sweep and the size of the wide beams.

Example 13 is a user equipment (UE) to implement radio resource management (RRM) for the UE, the UE in connection with a base station, the UE comprising: at least one antenna; at least one radio, wherein the at least one radio is configured to communicate with the base station using the at least one antenna; and at least one processor coupled to the at least one radio, wherein the at least one processor is configured to perform operations comprising: selecting a sub-sample of beams via the antenna from the base station based upon X and Y spatial coordinates from SSB index points; based on the selection of the sub-sample of beams based upon the X and Y spatial coordinates from SSB index points, implementing an artificial intelligence/machine learning (AI/ML) model function to: generate a course training image map; generate a prediction image map from the course training image map; and select an optimal beam pair from the prediction image map for communication with the base station.

Example 14 is the UE of example 13 that may optionally include that the X spatial coordinate from the SSB index point is a number that indicates the spatial direction order of the beam in azimuth.

Example 15 is the UE of example 13 that may optionally include the Y spatial coordinate from the SSB index point is a number that indicates the spatial direction order of the beam in elevation.

Example 16 is the UE of example 13 that may optionally include the sub-sample of beams includes narrow beams.

Example 17 is the UE of example 13 that may optionally include that the sub-sample of beams includes wide beams.

Example 18 is the UE of example 13 that may optionally include that the AI/ML model function is based upon 8×8 uniform planar array (UPA) Tx and a 4×4 Rx antenna array.

Example 19 is the UE of example 13 that may optionally include that the optimal beam pair from the prediction image map for communication with the base station includes a Tx, Rx pair.

Example 20 is the UE of example 13 that may optionally include that the course training image map is generated based upon training data of {X input, Y output} pairs, wherein X input represents a subset of beam pair reference signal received power (RSRP) measurements and the Y output represents the true full search RSRP measurements.

Example 21 is the UE of example 20 that may optionally include that the AI/ML model function is trained to find an inverse function: ƒ⁻¹(X)→Ŷ, wherein Ŷ corresponds to the prediction image map and X corresponds to the course training image map.

Example 22 is the UE of example 21 that may optionally include that the AI/ML model function predicts the optimal beam pair p {Tx,Rx} based upon an interpolated map [\hat{r},\hat{t}]_{1:p}=g(\vec{Y}), where g( ) returns the optimal peaks in Ŷ corresponding to the predicted image map.

Example 23 is the UE of example 13 that may optionally include that an additional field is included inside a radio resource control (RRC) configuration where spatial information is specified for the SSB burst including a coordinate system for the X and Y spatial coordinates.

Example 24 is the UE of example 13 that may optionally include that the sub-sample of beams includes wide beams and the wide beams are identified in an RRC configuration including a wide beam sweep and the size of the wide beams.

Example 25 is a UE baseband processor configured to cause a UE to perform one or more methods of examples 1 to 12.

Portions of what was described above may be implemented with logic circuitry such as a dedicated logic circuit or with a microcontroller or other form of processing core that executes program code instructions. Thus, processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

For example, the previously described embodiment operations may be stored as instructions on a non-transitory computer readable medium for execution by a computer (e.g., a UE). The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMS, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMS, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “selecting,” “determining,” “receiving,” “forming,” “grouping,” “aggregating,” “generating,” “removing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A method for radio resource management (RRM) for a user equipment (UE) in communication with a base station comprising:
selecting a sub-sample of beams from the base station based upon X and Y spatial coordinates from SSB index points;
based on the selection of the sub-sample of beams based upon the X and Y spatial coordinates from SSB index points, implementing an artificial intelligence/machine learning (AI/ML) model function to:
generate a course training image map;
generate a prediction image map from the course training image map; and
select an optimal beam pair from the prediction image map for communication with the base station.

2. The method of claim 1, wherein, the X spatial coordinate from the SSB index point is a number that indicates the spatial direction order of the beam in azimuth.

3. The method of claim 1, wherein, the Y spatial coordinate from the SSB index point is a number that indicates the spatial direction order of the beam in elevation.

4. The method of claim 1, wherein, the sub-sample of beams includes narrow beams.

5. The method of claim 1, wherein, the sub-sample of beams includes wide beams.

6. The method of claim 1, wherein, the AI/ML model function is based upon 8×8 uniform planar array (UPA) Tx and a 4×4 Rx antenna array.

7. The method of claim 1, wherein, the optimal beam pair from the prediction image map for communication with the base station includes a Tx, Rx pair.

8. The method of claim 7, wherein, the course training image map is generated based upon training data of {X input, Y output} pairs, wherein X input represents a subset of beam pair reference signal received power (RSRP) measurements and the Y output represents the true full search RSRP measurements.

9. The method of claim 8, wherein, the AI/ML model function is trained to find an inverse function: ƒ⁻¹(X)→Ŷ, wherein Ŷ corresponds to the prediction image map and X corresponds to the course training image map.

10. The method of claim 9, wherein, the AI/ML model function predicts the optimal beam pair p {Tx,Rx} based upon an interpolated map [\hat{r},\hat{t}]_{1:p}=g(Ŷ), where g( ) returns the optimal peaks in Ŷ corresponding to the predicted image map.

11. The method of claim 1, wherein, an additional field is included inside a radio resource control (RRC) configuration where spatial information is specified for the SSB burst including a coordinate system for the X and Y spatial coordinates.

12. The method of claim 1, wherein, the sub-sample of beams includes wide beams and the wide beams are identified in an RRC configuration including a wide beam sweep and the size of the wide beams.

13. A user equipment (UE) to implement radio resource management (RRM) for the UE, the UE in connection with a base station, the UE comprising:
at least one antenna;
at least one radio, wherein the at least one radio is configured to communicate with the base station using the at least one antenna; and
at least one processor coupled to the at least one radio, wherein the at least one processor is configured to perform operations comprising:
selecting a sub-sample of beams via the antenna from the base station based upon X and Y spatial coordinates from SSB index points;
based on the selection of the sub-sample of beams based upon the X and Y spatial coordinates from SSB index points, implementing an artificial intelligence/machine learning (AI/ML) model function to:
generate a course training image map;
generate a prediction image map from the course training image map; and
select an optimal beam pair from the prediction image map for communication with the base station.

14. The UE of claim 13, wherein, the X spatial coordinate from the SSB index point is a number that indicates the spatial direction order of the beam in azimuth.

15. The UE of claim 13, wherein, the Y spatial coordinate from the SSB index point is a number that indicates the spatial direction order of the beam in elevation.

16. The UE of claim 13, wherein, the sub-sample of beams includes narrow beams.

17. The UE of claim 13, wherein, the sub-sample of beams includes wide beams.

18. (canceled)

19. (canceled)

20. (canceled)

21. (canceled)

22. (canceled)

23. The UE of claim 13, wherein, an additional field is included inside a radio resource control (RRC) configuration where spatial information is specified for the SSB burst including a coordinate system for the X and Y spatial coordinates.

24. The UE of claim 13, wherein, the sub-sample of beams includes wide beams and the wide beams are identified in an RRC configuration including a wide beam sweep and the size of the wide beams.

25. (canceled)

26. A non-transitory computer-readable storage medium, comprising instructions that, when executed by one or more processors of a user equipment (UE) in communication with a base station, cause the UE to:
select a sub-sample of beams from the base station based upon X and Y spatial coordinates from SSB index points;
based on the selection of the sub-sample of beams based upon the X and Y spatial coordinates from SSB index points, implement an artificial intelligence/machine learning (AI/ML) model function to:
generate a course training image map;
generate a prediction image map from the course training image map; and
select an optimal beam pair from the prediction image map for communication with the base station.
